(19) United States
(12) Patent Application Publication
(10) Pub. No.: US 2016/0208124 A1
(43) Pub. Date: Jul. 21, 2016

(54) Conductive ink composition and conductive architecture for wireless antenna

(71) Applicant: CHUNG-PING LAI, Hsinchu County (TW)

(72) Inventor: CHUNG-PING LAI, Hsinchu County (TW)

(21) Appl. No.: 14/599,562

(22) Filed: Jan. 19, 2015

(51) Int. Cl. C09D 11/52; C09D 11/02

(52) U.S. Cl. CPC C09D 11/52; C09D 11/02

(57) ABSTRACT

A conductive ink composition for the wireless antenna with adhesion enhancement by carbon flakes that aims to enormously reduce the solid content of conductor and can be used to print antennas. For example, silver content of the ink composition is greatly decreased due to the absence of insulated binder. Carbon flakes (such as graphene nanoplatelets) are added as a conductive “cage” to reduce the use of insulated binder and significantly improve the conductivity of ink under low addition of conductor. Compression after printing is an innovative finding that not only improves the adhesion but also enhances the conductivity. Such effects are credited to excellent contact between interfaces of particles and substrate. The unique recipe and process save printing from high-temperature sintering, further reducing processing cost and widening applicable substrates.

### FIELD OF THE INVENTION

The present invention relates to a conductive ink composition and conductive architecture for wireless antenna which decrease their silver content but still maintain high conductivity.

### BACKGROUND OF THE INVENTION

Conductive inks for printing process like screen printing and inkjet printing are so expensive that the utilization of printing process cannot prevail over metal-etching process that result in high cost and poisonous pollution.

Metals like silver, nickel and copper as the conductive materials are the key reason why the price of conductive ink remains very high. How to cut down on the metal amount and still maintain the resistance is the key issue.

On the other hand, high sintering temperature of metals often confines the choices of substrates and application.

In the coming age of internet of things, wireless devices with antennas play an important role. Traditional antenna in devices is made of copper or aluminum by etching process. The process is not only expensive but also produces many high-pollution wastes. In addition, etching process also confines the choices of substrates. Therefore, printing processes such as screen printing and inkjet printing catch the spotlight recently.

Although printing processes are cost-saving and eco-friendly. The conductive inks in printing process are very expensive, and may suffer from poor stability or limited life time. Conductive materials in the conductive inks are made of metals like silver, nickel, and copper. Compared to carbon species, metallic conductors are both high-priced and have potential oxidation problems.

U.S. Pat. No. 7,763,187 disclosed that CNT (buckyballs, and graphene were also alternatively used) was proposed to bridge the gap between separated silver. The CNT-reinforced silver ink showed greater mechanical, electrical, and thermal properties. In this patent, silver content is 2 to 95 wt %.

U.S. Pat. No. 8,709,187 disclosed that aqueous silver ink for use in RFID was proposed. Sheet resistance can be as low as 120 mohm/sq (˜24 mohm/sq/mil), by which the read range was at least 3 meter. Carbon, typically carbon black and graphite, may also be used as conductive materials. Silver content is about 50 to 70 wt % of the composition, and resins is about 4 to 10 wt %.

Furthermore, CN Publication No. 103436099 taught that a low-cost silver/carbon ink was proposed for screen printing. Ink consists of 55 to 72 wt % of C/Ag composites and 10 to 25 wt % of conductive resins. Coating can be dried under 130° C. to 150° C. Cost was said to save 30%.

The present invention has arisen to mitigate and/or obviate the afore-described disadvantages.

### SUMMARY OF THE INVENTION

The primary objective of the present invention is to provide a conductive ink composition and conductive architecture for wireless antenna which decrease their silver content but still maintain high conductivity.

To obtain above objective, a conductive ink composition and conductive architecture for wireless antenna provided by the present invention contain: silver flakes and/or silver powders, carbon powders, at least one dispersant, and a solvent.

The silver flakes and/or the silver powders have a grain size ranging from 10 nm to 100 μm.

The carbon powders use as conductive “cage” and consist of at least one of graphene, natural graphite, flake-shaped carbon black (Ex: KS6) and ball-shaped graphite.

The at least one dispersant is added at 0.01 to 0.1 wt % of a total solid content of a conductive ink composition.

The solvent has at least one carrier and accounts for 30 to 75 wt % of the conductive ink composition.

The silver flakes and/or the silver powders account for 10 to 60 wt % of the conductive ink composition.

The carbon powders are 5 to 20 wt % of the total solid content of the conductive ink composition, a thickness of the carbon powders ranges from 1 to 10000 nm, and a grain size of the carbon powders is from 0.1 to 100 μm.

### BRIEF DESCRIPTION OF THE DRAWINGS

FIG. 1a is a schematic illustration of binder-free conductive carbon “cage” according to the present invention.

FIG. 1b is a schematic illustration of conductive carbon “cage” to catch metal particles in carbon laminate according to the present invention.

FIG. 2a is SEM images of commercial silver ink coating.

FIG. 2b is a SEM image of the binder-free silver/carbon ink showing that graphitic carbon flakes trapped silver particles and filled the voids in between according to the present invention.

FIG. 3a is a SEM image of binder-free silver/carbon ink coating before compression according to the present invention.

FIG. 3b is a SEM image of the binder-free silver/carbon ink coating after compression according to the present invention.

FIG. 4a is a diagram showing a sample #1 silver ink without binder according to the present invention.

FIG. 4b is a diagram showing a sample #2 silver ink with binder according to the present invention.

FIG. 4c is a diagram showing a sample #3 silver/carbon (A) ink without binder according to the present invention.

FIG. 4d is a diagram showing a sample #4 silver/carbon (B) ink without binder according to the present invention.

FIG. 5 is a comparison list showing the resistance performance of the sample #1 to #4 according to the present invention.

FIG. 6 is a comparison list showing the compression effect of the sample #1 to #4 according to the present invention.

FIG. 7 is a comparison list showing one binder-free silver/carbon ink with 45 wt % of silver content according to the present invention.

FIG. 8 is a table showing the read range of RFID, wherein at least 4 meters can be reached, which indicated wide application of screen-printed antenna by our ink according to the present invention.

### DETAILED DESCRIPTION OF THE PREFERRED EMBODIMENTS

A conductive ink composition and conductive “cage” for wireless antenna according to the present invention decrease their silver content but still maintains high conductivity.

There are mainly two methods in the preceding ink history: 1. Adjusting conductive materials like adding supplementary metals, carbons, or surface-treated silver; and 2. Replacing insulate binder with conductive polymers.

Carbon can be used as a conductive linkage, for example, carbon materials such as graphene, CNT, graphite, etc., have been widely proposed to be either added as supplementary conductive materials or as conductive bridging between silver particles.

On top of the foregoing proposal, we propose carbon nanoflakes not only can function as conductive “cage” but also as a matrix of cage to catch the conductive particles.

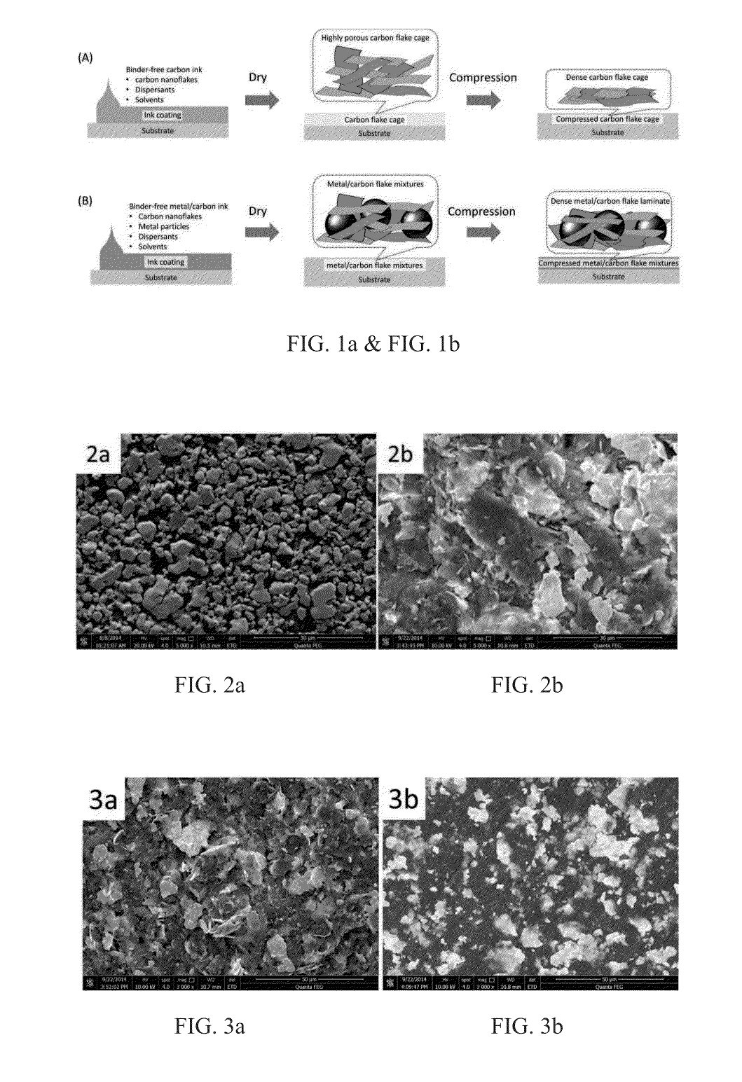

As a schematic illustration shown in FIG. 1a, carbon flakes will build a highly porous mixture that was proposed as conductive carbon “cage” in the present invention. On the other hand, compression was further applied to close the porous space to form a dense conductive laminate. In FIG. 1b, metal powders was trapped and linked by the conductive carbon “cage” unlike the case of insulator-typed binders. The door of this cage was closed to grip metal particles without any binder connection after compression. The absence of insulator-typed binders makes ink more conductive. Therefore, this idea leads to binder-free metal/carbon ink, which greatly enhances the conductivity due to the absence of insulate binder. Carbon flake in this invention is not only conductive material but also an efficient cage to catch metal particles.

The adhesive ability of graphitic carbon flake results from van der Waal forces between interfaces. Since van der Waal force is counter-proportional to distance, adhesion can be improved by purely compression of the coating without any help of binders.

From SEM images of commercial silver ink, as shown in FIG. 2a, plenty of voids can be found. Therefore, sintering between particles and binders are indispensable to ensure metal connection and ink adhesion. On the other hand, as illustrated in FIG. 2b, SEM image of the silver/carbon ink in this invention showed that the voids between silver was completely filled by graphitic carbon flakes. With its adhesive ability, carbon flakes not only trap silver particles but also works as an effective binder.

As mentioned previously, compression, decreasing the distance between graphitic carbon flakes and other interfaces, can greatly enhance the adhesion. Such concept is more practical as the silver content within ink composition is at low level. Nevertheless, compression also helps the connection within silver-silver interface, regardless of the presence of carbon in between, because silver is a ductile metal. It is therefore saving inks from high-temperature sintering process.

The concept of conductive graphene cage was further identified by the SEM observation. From SEM images of as-deposited and compressed coating, as shown in FIGS. 3a and 3b, improved contacts can be observed. As-deposed silver/carbon coating exhibited a porous and irregular architecture, which became dense film after rolling compression. Thus, porous carbon nanoflake mixture was considered as a conductive “cage” to catch Ag particles without any binder connection after rolling compression. So compressed coating with firm contacts between particles and surfaces illustrate both high conductivity and good adhesion.

The primary conductive materials are silver flakes and/or silver powders with a grain size ranging from 10 nm to 100 μm. Carbon powders use as conductive “cage” and consist of at least one of graphene, natural graphite, flake-shaped carbon black (Ex: KS6) and ball-shaped graphite. A thickness of the carbon powders ranges from 1 to 10000 nm, and a grain size of the carbon powders is from 0.1 to 100 μm. The silver flakes and/or silver powders account for 10 to 60 wt % of the conductive ink composition; and the carbon powders are 5 to 20 wt % of a total solid content of the conductive ink composition.

Dispersant is also contained in the conductive ink composition. It can be either non-ionic dispersant such as P-123, Tween 20, Xanthan gum, Carboxymethyl Cellulose (CMC), LA132, Triton X-100, Polyvinyl Alcohol (PVA), Polyvinylpyrrolidone (PVP), Brji 30, or ionic dispersant like Poly(sodium 4-styrenesulfonate) (PSS), 3-[(3-Cholamidopropyl)dimethyl ammonio]-1-propanesufonate (CHAPS), Hexadecyltrimethylammonium bromide (HTAB), Sodium taurodeoxycholate hydrate (SDS), 1-Pyrenebutyric acid (PBA). At least one of the dispersants is added at 0.01 to 0.1 wt % of the total solid content.

Solvent of the conductive ink composition can possess one or more carriers. Carriers can be aqueous, organic, or inorganic. Examples of suitable carriers include Methyl-2-pyrrolidone (NMP), IPA (Isopropyl alcohol), ethanol, glycerol, ethylene glycol, butanol, propanol, propylene glycol monomethyl ether (PGME), propylene glycol monomethyl ether acetate (PGMEA), Benzene, Toluene. Solvent accounts for 30 to 75 wt % of the conductive ink composition.

Thermal drying is the main drying method of the conductive ink. Heating temperature can be within 30 to 300° C. The higher the temperature is, the faster the drying is realized. After drying, antenna is further compressed to raise adhesion and density of the carbon conductive line. Compression ratio is 0.5 to 99% of the original thickness.

In an adhesion test, we fixed the silver amount at a very low level (15 wt % of the total composition), and added conductive carbon and binder, respectively at a fixed amount (around 30 wt %) for both adhesion and resistance comparison. Pure silver ink is also compared. However, silver amount needs to increase to 45 wt % for pure silver to have acceptable coating.

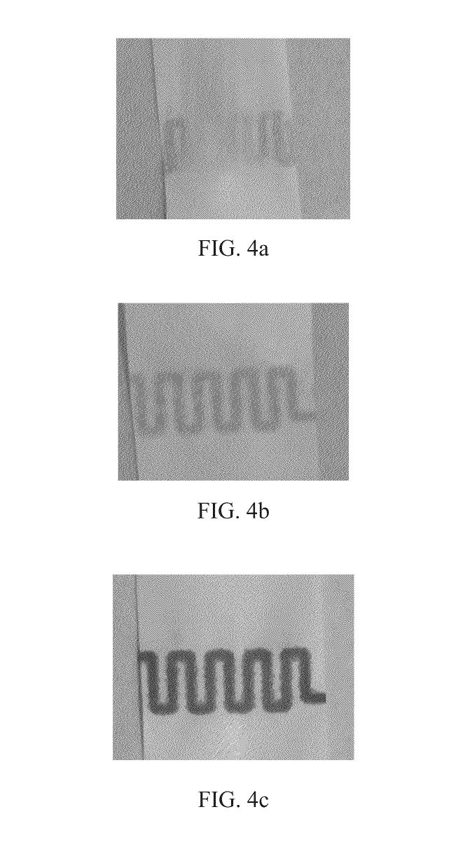

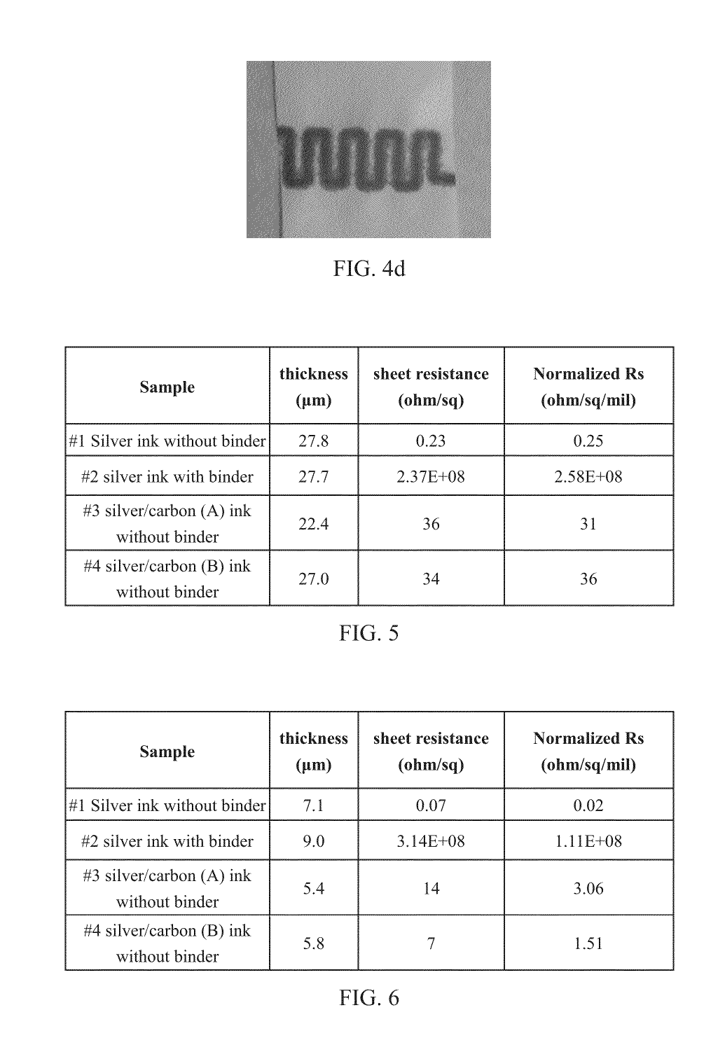

FIG. 4a is a diagram showing a sample #1 silver ink without binder according to the present invention; FIG. 4b is a diagram showing a sample #2 silver ink with binder according to the present invention; FIG. 4c is a diagram showing a sample #3 silver/carbon (A) ink without binder according to the present invention; and FIG. 4d is a diagram showing a sample #4 silver/carbon (B) ink without binder according to the present invention, wherein the recipe composition of carbon is different in sample #3 and sample #4.

After wiping, one can find that silver with carbon has excellent adhesion comparable to binder. However, conductive line of pure silver ink was almost wiped out.

With reference to FIG. 5, in the resistance performance, silver ink without binder shows relatively low resistance because the amount of silver is three times higher (45 wt % compared to 15 wt %).

Silver ink with binder showed extremely high resistance, because binders were insulators and the conductive silver was too little to forge conductive channels within binders.

Furthermore, silver/graphitic carbon without binder then exhibited good conductivity. This illustrates strong evidence that ink composition in this invention had great competitiveness in resistance, adhesion, and price.

As illustrated in FIG. 6, a compression effect on the resistance is observed, wherein the compression can enormously reduce the resistance up to one order smaller for both pure silver and silver with carbon.

Carbon composition was also found to affect the resistance.

Note that with only 15 wt % of silver in the total ink composition, the resistance of ink can reach as low as 1.5 ohm/sq/mil. This shows flexibility of resistance by adjusting the composition under relatively low silver amount, implying the low cost benefit.

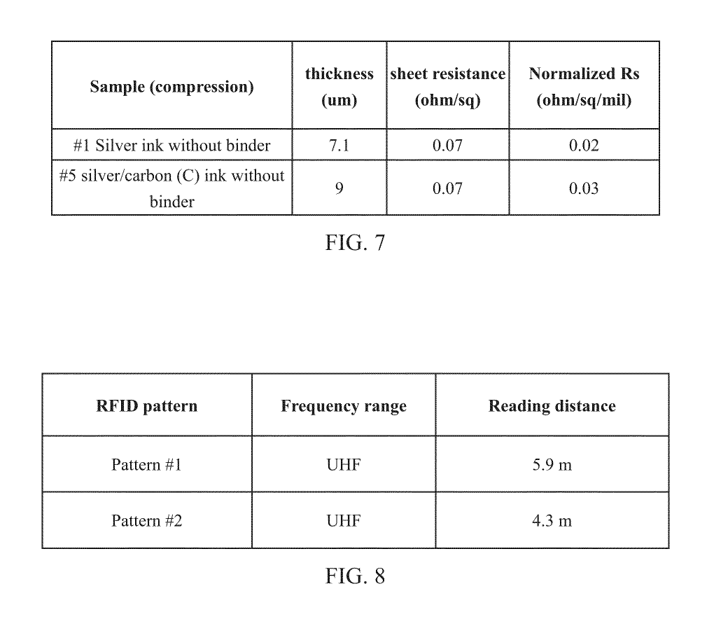

As shown in FIG. 7, we present one of our binder-free silver/carbon (C) ink with 45 wt % of silver content (the same as pure silver ink in previous exhibition). One can find that the resistance is almost the same. This exhibited that carbon nanoflakes can significantly improve adhesion without any resistance influence.

Thereafter, binder-free silver/carbon ink was printed onto papers in different antenna patterns by screen printing. Referring to FIG. 8, the read range is shown in the table, wherein at least 4 meters can be reached, which indicated wide application of screen-printed antenna by our ink.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A conductive ink composition for wireless antenna comprising:
silver flakes and/or silver powders with a grain size ranging from 10 nm to 100 μm;
carbon powders using as conductive “cage” and consisting of at least one of graphene, natural graphite, flake-shaped carbon black (Ex: KS6) and ball-shaped graphite;
at least one dispersant added at 0.01 to 0.1 wt % of a total solid content of a conductive ink composition;
a solvent having at least one carrier and accounting for 30 to 75 wt % of the conductive ink composition; wherein
the silver flakes and/or silver powders account for 10 to 60 wt % of the conductive ink composition;
the carbon powders are 5 to 20 wt % of the total solid content of the conductive ink composition, a thickness of the carbon powders ranges from 1 to 10000 nm, and a grain size of the carbon powders is from 0.1 to 100 μm.

2. The conductive ink composition for the wireless antenna as claimed in claim 1, wherein the at least one dispersant is non-ionic dispersant.

3. The conductive ink composition for the wireless antenna as claimed in claim 2, wherein the non-ionic dispersant is any one of P-123, Tween 20, Xanthan gum, Carboxymethyl Cellulose (CMC), LA132, Triton X-100, Polyvinyl Alcohol (PVA), Polyvinylpyrrolidone (PVP), and Brji 30.

4. The conductive ink composition for the wireless antenna as claimed in claim 1, wherein the at least one dispersant is ionic dispersant.

5. The conductive ink composition for the wireless antenna as claimed in claim 4, wherein the ionic dispersant is any one of Poly (sodium 4-styrenesulfonate) (PSS), 3-[(3-Cholamidopropyl) dimethyl ammonio]-1-propanesufonate (CHAPS), Hexadecyltrimethylammonium bromide (HTAB), Sodium taurodeoxycholate hydrate (SDS), and 1-Pyrenebutyric acid (PBA).

6. The conductive ink composition for the wireless antenna as claimed in claim 1, wherein the at least one carrier is any one of aqueous, organic, and inorganic; the at least one carrier includes any one of Methyl-2-pyrrolidone (NMP), IPA (Isopropyl alcohol), ethanol, glycerol, ethylene glycol, butanol, propanol, propylene glycol monomethyl ether (PGME), propylene glycol monomethyl ether acetate (PGMEA), Benzene, and Toluene.

7. A conductive cage architecture for the wireless antenna is built from a conductive ink as claimed in claim 1, wherein compression is further applied to close the porous space of conductive cage and let it catches metal powders well.
